(19) United States
(12) Patent Application Publication
(10) Pub. No.: US 2016/0236346 A1
(43) Pub. Date: Aug. 18, 2016

(54) MULTI-LINK TYPE WORKING APPARATUS MOVED BY THRUST GENERATING DEVICE

(71) Applicant: Seoul National University R&DB Foundation, Seoul (KR)

(72) Inventors: DONG JUN LEE, Seoul (KR); HAI NGUYEN NGUYEN, Seoul (KR); SANGYUL PARK, Daegu (KR)

(21) Appl. No.: 14/923,442

(22) Filed: Oct. 27, 2015

(30) Foreign Application Priority Data
Feb. 17, 2015 (KR) 10-2015-0024404

(51) Int. Cl. B25J 9/10; B64C 39/02; B25J 9/16

(52) U.S. Cl. CPC B25J 9/10; B25J 9/106; B25J 9/162; B64C 39/024; B64C 2201/024; B64C 2201/108; B64C 2201/128; B64C 2201/14

(57) ABSTRACT

A multi-link type working apparatus moved by a thrust generating device is provided. The multi-link type working apparatus performs a work by moving a link apparatus, in which a plurality of links are connected by at least one joint, by using the thrust generating device. The multi-link type working apparatus moved by a thrust generating device may variously expand lengths of links, the number of links, and the freedom of movement by using the thrust generating device as an actuator for moving the links, compared to a general multi-link type working apparatus that uses a motor or a hydraulic cylinder as an actuator.

### RELATED APPLICATION

This application claims the benefit of Korean Patent Application No. 10-2015-0024404, filed on Feb. 17, 2015, in the Korean Intellectual Property Office, the disclosure of which is incorporated herein in its entirety by reference.

### BACKGROUND

1. Field

One or more exemplary embodiments relate to a multi-link type working apparatus, and more particularly, to a multi-link type working apparatus moved by a thrust generating device, wherein the multi-link type working apparatus performs a work by moving a link apparatus, in which a plurality of links are connected by at least one joint, by using the thrust generating device.

2. Description of the Related Art

A multi-link type working apparatus having a structure in which a plurality of links are connected by at least one joint is used in various fields. The multi-link type working apparatus has a simple structure but is capable of performing a complex work, such as nonlinear movement or force transmission.

A general multi-link type working apparatus includes a link apparatus in which a plurality of links are connected by at least one joint, and an actuator driving the link apparatus. One end of the link apparatus is fixed, and an end effector for various works is provided at another end of the link apparatus. Each of the links forming a link assembly is moved by the actuator, such as a motor or a hydraulic cylinder.

Types of a multi-link type working apparatus may vary and may include an industrial robot, a manipulator, and a crane. For example, KR 0292013 (published on Feb. 19, 2002) discloses a crane in which a hydraulic cylinder moves connected links to transfer garbage to an incinerator. Also, KR 1229025 (published on Feb. 01, 2013) discloses a multi-joint manipulator that is able to collect an accident vehicle or a disable vehicle by including a pivot joint or a prism joint. KR 2013-0042247 (published on Apr. 26, 2013) discloses a manipulator in which a pair of auxiliary links are connected to a main rotary link via a pair of brackets to be used for a palletizing operation in an industrial site.

A general multi-link type working apparatus has a restriction on the length or number of links due to a limitation of an actuator operating a link, and has a low degree of freedom of a mid-air operation. When the number of links is high or the length of each link is long, torque of the general multi-link type working apparatus, which is required to operate the links, may geometrically increase.

### SUMMARY

One or more exemplary embodiments include a multi-link type working apparatus moved by a thrust generating device, in which lengths of links, the number of links, and the freedom of movement may be varied by using the thrust generating device as an actuator for moving the links.

Additional aspects will be set forth in part in the description which follows and, in part, will be apparent from the description, or may be learned by practice of the presented embodiments.

According to one or more exemplary embodiments, a multi-link type working apparatus moved by a thrust generating device, includes a link apparatus that comprises a plurality of links and at least one joint connecting two neighboring links between each of the plurality of links; a plurality of thrust generating device that comprise a control module enabling communication between an external device and a rotor generating thrust to control operations of the rotor, and are respectively combined to the plurality of links of the link apparatus to move the plurality of links; and a control device that comprises a controller in which a control process for controlling the plurality of thrust generating device is stored, and a communicator transmitting a control signal to the plurality of thrust generating device according to the control process.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram of a multi-link type working apparatus moved by a thrust generating device, according to an exemplary embodiment;

FIG. 2 is an exploded diagram of some components of the multi-link type working apparatus of FIG. 1, according to an exemplary embodiment;

FIG. 3 is a diagram for describing a peg-in-hole operation performed by the multi-link type working apparatus of FIG. 1;

FIG. 4 is a diagram of a multi-link type working apparatus moved by a thrust generating device, according to another exemplary embodiment;

FIG. 5 is an exploded diagram of some components of a multi-link type working apparatus moved by a thrust generating device, according to another exemplary embodiment; and

FIG. 6 is a diagram of a multi-link type working apparatus moved by a plurality of thrust generating devices, according to another exemplary embodiment.

### DETAILED DESCRIPTION

A multi-link type working apparatus moved by a thrust generating device, according to one or more exemplary embodiments, will now be described with reference to accompanying drawings, wherein like reference numerals refer to like elements throughout.

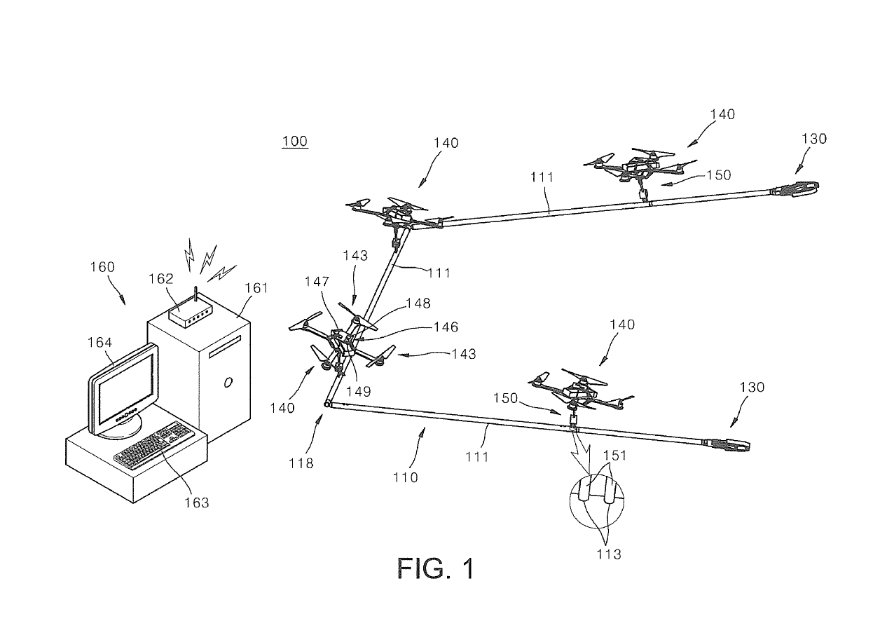

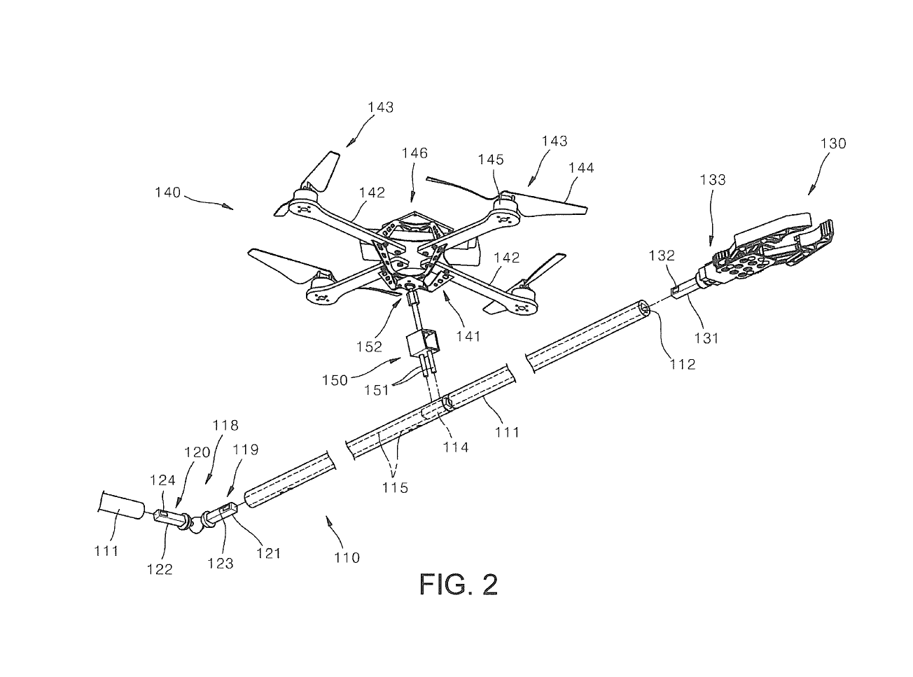

FIG. 1 is a diagram of a multi-link type working apparatus 100 moved by a thrust generating device 140, according to an exemplary embodiment, and FIG. 2 is an exploded diagram of some components of the multi-link type working apparatus 100 of FIG. 1, according to an exemplary embodiment.

As shown in FIGS. 1 and 2, the multi-link type working apparatus 100 includes a link apparatus 110, a plurality of the thrust generating devices 140, and a control device 160. The multi-link type working apparatus 100 may perform various works by moving the link 110 by using the plurality of thrust generating devices 140.

The link apparatus 110 includes a plurality of links 111 and a plurality of joints 118. A combining groove 112 for combining of the joint 118 may be provided at each of two ends of the link 111. A plurality of insertion grooves 113 and a connection module 114 for connecting of the thrust generating device 140 are provided at the middle of the link 111. The connection module 114 is for electric connection with the thrust generating device 140. An electric wire 115 connected to the connection module 114 is provided inside the link 111.

The plurality of joints 118 connect the two neighboring links 111 between each of the plurality of links 111. According to the current embodiment, the joint 118 has a ball joint structure in which a first connecting member 119 includes a ball and a second connecting member 120 includes a socket into which the ball is inserted. A first combining protrusion 121 is provided at an end of the first connecting member 119, and a second combining protrusion 122 is provided at an end of the second connecting member 120. The first combining protrusion 121 of the first connecting member 119 is inserted into the combining groove 112 of any one of the links 111, and the second combining protrusion 122 of the second connecting member 120 is inserted into the combining groove 112 of the other one of the links 111. The first and second combining protrusions 121 and 122 respectively include terminals 123 and 124 for electric connection. The terminal 123 of the first combining protrusion 121 and the second terminal 124 of the second combining protrusion 122 may be mutually electrically connected to each other. At this time, an electric wire (not shown) for electrically connecting the terminals 123 and 124 may be provided inside the joint 118. The terminals 123 and 124 may be connected to each other via a cable provided outside the joint 118.

The first and second combining protrusions 121 and 122 of the joint 118 are respectively combined to the two neighboring links 111, and thus the joint 118 connects the two neighboring links 111 such that joint movement is possible, and at the same time, electrically connects the two neighboring links 111. Accordingly, the plurality of thrust generating devices 140 connected to the connection module 114 of each of the plurality of links 111 may be mutually electrically connected to each other through the plurality of links 111 and the plurality of joints 118.

An end effector 130 is provided at an end of the link apparatus 110. According to the current embodiment, the end effector 130 has a gripper structure having a function of gripping an object. The end effector 130 has a combining protrusion 131 that is inserted into the combining groove 112 of the link 111. The end effector 130 is detachably combined to the link 111 through the combining protrusion 131. The combining protrusion 131 of the end effector 130 includes a terminal 132 for electric connection. A driver 133 of the end effector 130 may receive power and a control signal through the terminal 132. When the combining protrusion 131 of the end effector 130 is inserted into the combining groove 112 of the link 111, the terminal 132 of the end effector 130 is electrically connected to the electric wire 115 of the link 111. Accordingly, the end effector 130 may receive power and the control signal through the link 111, and may be electrically connected to the thrust generating device 140 combined to the link 111, through the link 111. In FIG. 1, a pair of the end effectors 130 are provided respectively at two ends of the link apparatus 110, but alternatively, the end effector 130 may be provided only at one end of the link apparatus 110.

As shown in FIG. 1, the plurality of thrust generating devices 140 are respectively combined to the plurality of links 111 of the link apparatus 110 to move the plurality of links 111. According to the current embodiment, the thrust generating device 140 is a multi-rotor type unmanned aerial vehicle (UAV) having a plurality of rotors 143. As widely known, a multi-rotor type UAV has a simple structure and is capable of vertical takeoff and landing, prompt flight, and hover flight.

Referring to FIG. 2, the thrust generating device 140 includes a support frame 141, the plurality of rotors 143 provided at the support frame 141, and a control module 146 controlling operations of the plurality of rotors 143. The support frame 141 includes four mounts that radially extend from a center of the support frame 141. The control module 146 is provided at the center of the support frame 141, and the rotor 143 is provided at each of the four mounts 142. The rotor 143 includes a wing 144 and a motor 145 to generate thrust. Operations of the rotor 143 are controlled by the control module 146.

As shown in FIG. 1, the control module 146 generates a rotating direction and a rotating speed of each of the plurality of rotors 143. The control module 146 includes a processor 147, a position detector 148 such as an inertial measurement unit (IMU), and a communication module 149. The control module 146 detects a flight state of the thrust generating device 140 and controls operations of the rotor 143, thereby controlling flight of the thrust generating device 140. Also, the control module 146 may be in wireless communication with the control device 160 on the ground through the communication module 149. The control module 146 may receive a control signal from the control device 160 via communication with the control device 160 to control operations of the thrust generating device 140, and transmit information about a state of the thrust generating device 140 to the control device 160.

The thrust generating device 140 is detachably combined to the link 111 through a link connecting apparatus 150. The link connecting apparatus 150 includes a pair of insertion protrusions 151 inserted into the insertion groove 113 of the link 111, and a joint 152 combined to the support frame 141 of the thrust generating device 140. According to the current embodiment, the joint 152 has a ball joint structure. When the thrust generating device 140 is combined to the link 111 through the link connecting apparatus 150 having the joint 152, an angle of the thrust generating device 140 with respect to the link 111 may be variously adjusted. Accordingly, the link 111 may stably and smoothly move as the thrust generating device 140 tilts in any angle with respect to the link 111. A structure of the joint 152 may not only be the ball joint structure, but may also be any other structure in which the thrust generating device 140 is combined to the link 111 such that the angle of the thrust generating device 140 is adjustable. The link connecting apparatus 150 may not include a joint.

The link connecting apparatus 150 mechanically combines, and at the same time, electrically connects, the link 111 and the thrust generating device 140. Accordingly, an electric wire (not shown) for electric connection is provided inside the joint 152. The insertion protrusion 151 of the link connecting apparatus 150 is electrically connected to the connection module 114 of the link 111 when inserted into the insertion groove 113 of the link 111. Accordingly, the plurality of thrust generating devices 140 combined to the link apparatus 110 may be mutually electrically connected to the plurality of links 111 through the plurality of joints 118, and may also be electrically connected to the pair of end effectors 130 combined to the link apparatus 110.

As such, when the plurality of thrust generating devices 140 and the pair of end effectors 130 are all electrically connected, the control module 146 provided in any one of the plurality of thrust generating devices 140 may be used as a main controller controlling the plurality of thrust generating apparatuses 140 and the pair of end effectors 130. In other words, the control module 146 provided in any one of the plurality of thrust generating devices 140 combined to the link apparatus 110 may receive a control signal from the control device 160, and integrally operate the plurality of thrust generating devices 140 and the end effectors 130 such that a work using the end effectors 130 is smoothly performed.

When the thrust generating device 140 is combined to the link 111 of the link apparatus 100 through the link connecting apparatus 150, the thrust generating device 140 may transmit information about its location on the link apparatus 110 to the control device 160. When all of the thrust generating devices 140 transmits the information about their locations on the link apparatus 110 to the control device 160, the control device 160 may control operations of each of the thrust generating devices 140 such that the plurality of links 111 integrally move for a work. The information about the locations may be provided via any one of various methods. For example, a location code may be set per connection module 114 of the link 111, and when the insertion protrusion 151 of the link connecting apparatus 150 is connected to the connection module 114, the location code of the connection module 114 may be transmitted to the thrust generating device 140 connected to the link connecting apparatus 150.

The control device 160 includes a controller 161, a communicator 162, a manipulator 163, and a display 164. The communicator 162 is in communication with the thrust generating device 140, and the display 164 may display various types of information about the multi-link type working apparatus 100, such as an operating state of the multi-link type working apparatus 100. The controller 161 stores a control process for controlling the end effector 130 and the thrust generating device 140. The controller 161 transmits a control signal for operating the end effector 130 and the plurality of thrust generating devices 140 according to the stored control process to the thrust generating device 140 through the communicator 162. At this time, the control module 146 of the thrust generating device 140, which operates as a main controller, may control operations of the thrust generating devices 140 and the end effector 130 according to the control signal.

The manipulator 163 is used for a user input. A user may input a manipulation signal regarding the thrust generating device 140 or the end effector 130, select a pre-set work mode, or change a work setting, through the manipulator 163.

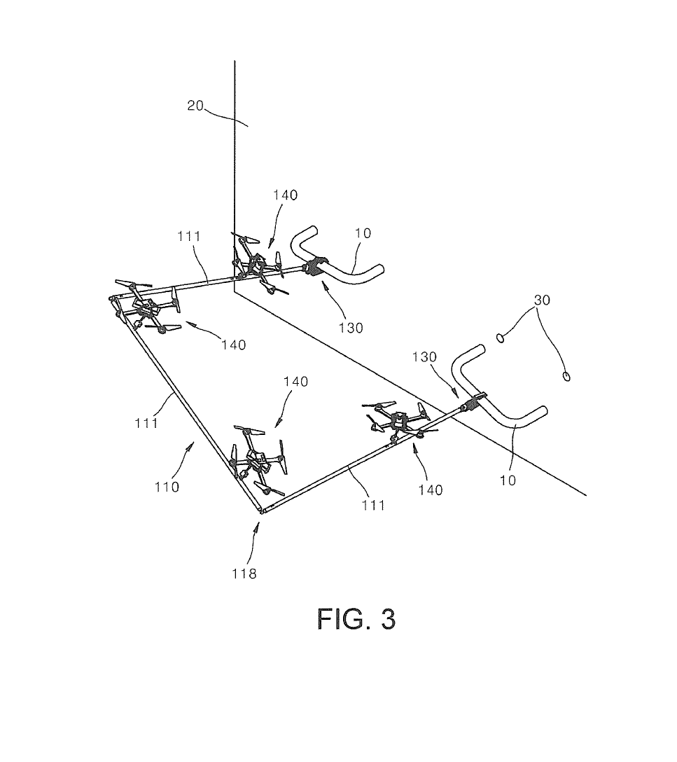

FIG. 3 is a diagram for describing a peg-in-hole operation performed by the multi-link type working apparatus 100 of FIG. 1. As shown in FIG. 3, the multi-link type working apparatus 100 according to the current embodiment may perform a work of inserting a peg 10 into a hole 30 formed on a wall 20 by moving the links 111 of the link apparatus 110 by using the plurality of thrust generating device 140 while the end effector 130 combined to the link apparatus 110 holds the peg 10. The multi-link type working apparatus 100 may easily perform the peg-in-hole operation that is difficult and dangerous to be performed by a person since the plurality of thrust generating device 140 lift the link apparatus 110 to any height in mid-air.

In addition, the multi-link type working apparatus 100 according to an exemplary embodiment may perform various unmanned works as various end effectors having various working functions are replaced and combined at the link apparatus 110. The multi-link type working apparatus 100 according to an exemplary embodiment may variously change the degree of freedom of the link apparatus by changing the number or structures of the links 111, constraint conditions of the links 111, and a structure of the joint 118. A structure or the number of the thrust generating device 140 may also be changed.

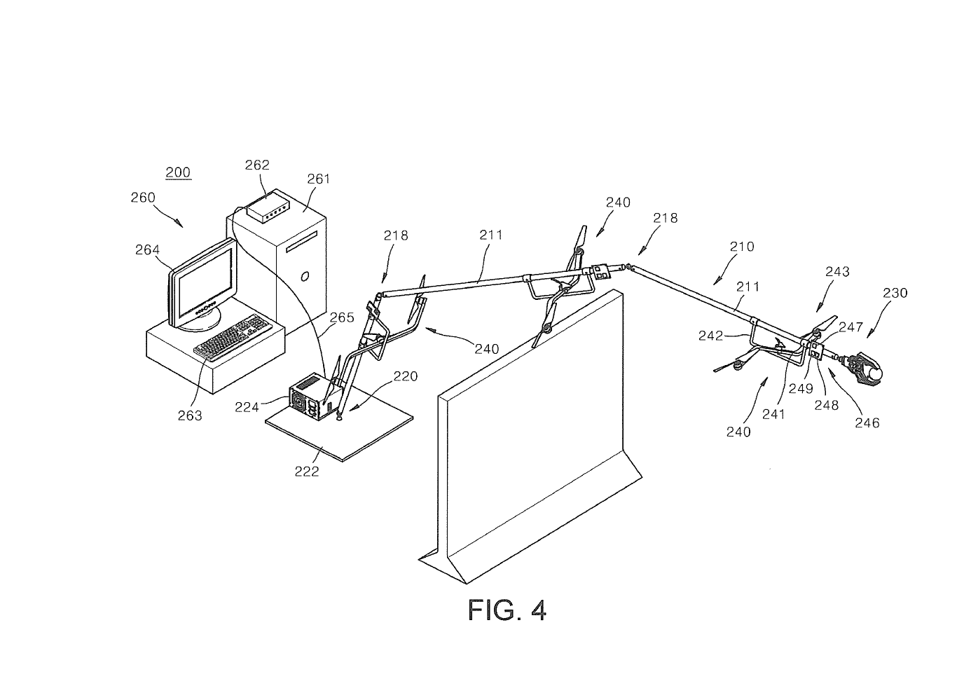

FIG. 4 is a diagram of a multi-link type working apparatus 200 moved by a thrust generating device 240, according to another exemplary embodiment. The multi-link type working apparatus 200 of FIG. 4 includes a link apparatus 210, the plurality of thrust generating devices 24, and a control device 260.

The link apparatus 210 includes a plurality of links 211 and a plurality of joints 218. The joint has a ball joint structure, and connects the links 211 to each other. An end effector 230 is detachably combined to the link 211 at one end of the link apparatus 210. According to the current embodiment, the end effector 230 has a gripper structure. The link 211 at the other end of the link apparatus 210 is connected to a base 222 through a joint 220. The joint 220 has a ball joint structure. The base 222 supports the link apparatus 210. The link apparatus 210 is constrained from moving by the joint 220, and may tilt in any angle with respect to the base 222.

A power supply apparatus 224 for supplying power is provided at the base 222. An electric wire (not shown) is provided inside the link apparatus 210, and power of the power supply apparatus 224 may be provided to the end effector 230 through the link apparatus 210 or to the plurality of thrust generating device 240 combined to the link apparatus 210. A control signal of the control device 260 may be transmitted to the end effector 230 or the plurality of thrust generating devices 240 through the electric wire inside the link apparatus 210.

The plurality of thrust generating device 240 are respectively combined to the plurality of links 211 of the link apparatus 210 to move the plurality of links 211. The thrust generating device 240 includes a support frame 241, a plurality of rotors 243 provided at the support frame 241, and a control module 246 controlling operations of the plurality of rotors 243. The support frame 241 is combined to a fixture 242 fixed to the link 211. An electric wire (not shown) is provided inside the support frame 241 and the fixture 242 to transmit power and a control signal to the plurality of thrust generating devices 240. Operations of the rotor 243 are controlled by the control module 246.

The control module 246 is combined to the link 211. The control module 246 controls a rotating direction and a rotating speed of each of the plurality of rotors 243. The control module 246 includes a processor 247, a position detector 248 such as an IMU, and a communication module 249. The control module 246 receives power and a control signal through the link apparatus 210, detects a flight state of the thrust generating device 240, and controls operations of the rotor 243.

The control device 260 includes a controller 261, a communicator 262, a manipulator 263, and a display 264. The structure of the control device 260 is similar to that described above. The communicator 262 is electrically connected to the link apparatus 210 through a cable 265 to be connected to the end effector 230 and the plurality of thrust generating devices 240 via wires. The controller 261 transmits a control signal for operating the end effector 230 and the plurality of thrust generating devices 240 according to the stored control process to the end effector 230 and the plurality of thrust generating devices 240 through the communicator 262.

The multi-link type working apparatus 200 according to the current embodiment uses constraint conditions in which one end of the link apparatus 210 is connected to the base 222. Accordingly, operation instability caused by under-actuation may be reduced and stable operation may be performed. By replacing the end effector 230 to another end effector having various functions, various works as well as grabbing an object may be performed. Also, since power may be continuously supplied to the end effector 230 or the plurality of thrust generating devices 240 from the ground, a work may be performed for hours.

According to the current embodiment, the thrust generating device 240 may be detachably combined to the link apparatus 210 as described in the previous embodiment. An electric wire may not be provided inside the link apparatus 210, but a separate cable may be disposed outside the link apparatus 210, thereby transmitting power and a control signal to the end effector 230 and the plurality of thrust generating devices 240 through the separate cable.

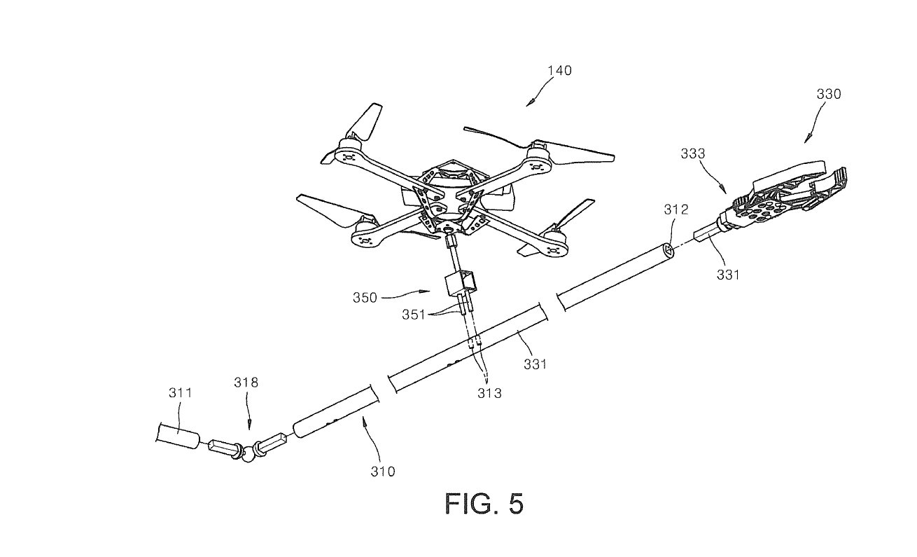

An end effector or a thrust generating device may not be mutually electrically connected to each other through a link apparatus, but may operate by individually receiving a control signal from a control device. For example, FIG. 5 illustrates an end effector 330 and the thrust generating device 140 being simply mechanically combined to a link apparatus 310.

According to the current embodiment, a plurality of links 311 of the link apparatus 310 is only mechanically connected to each other by a joint 318. The end effector 330 is detachably combined to the link apparatus 310 as a combining protrusion 331 of the end effector 330 is inserted into a combining hole 312 of the link 311. The thrust generating device 140 is detachably combined to the link 311 by a link connecting apparatus 350. The link connecting apparatus 350 includes an insertion protrusion 351 that is inserted into an insertion groove 313 provided in the link 311. According to the current embodiment, the end effector 330 may include a communicator (not shown) as well as a driver 333, and operate upon receiving a control signal from a control device via wireless communication.

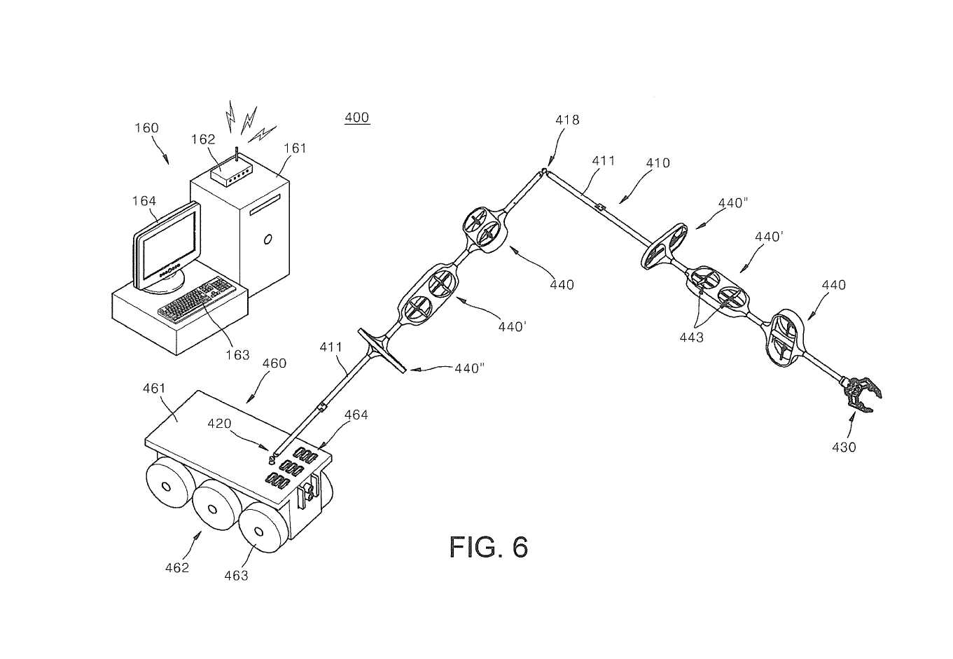

FIG. 6 is a diagram of a multi-link type working apparatus 400 moved by a plurality of thrust generating devices 440, 440′, and 440″, according to another exemplary embodiment. The multi-link type working apparatus 400 of FIG. 6 includes a link apparatus 410, the plurality of thrust generating devices 440 through 440″, a moving apparatus 460, and the control device 160. Here, the control device 160 has been described above with reference to FIG. 1.

The link apparatus 410 includes a plurality of links 411 and a plurality of joints 418. An end effector 430 is detachably combined to the link 411 at one end of the link apparatus 410. According to the current embodiment, the end effector 430 has a gripper structure. The link 411 at the other end of the link apparatus 410 is connected to the moving apparatus 460 through a joint 420. The link apparatus 410 may be constrained from moving as the link apparatus 410 is combined to the moving apparatus 460 via the joint 420, and may tilt in any angle with respect to the moving apparatus 460.

The moving apparatus 460 may move on the ground by including a body 461, a moving mechanism 462 including a plurality of wheels 463, and a control unit 464. The body 461 may include a power supply apparatus (not shown) to supply power to the moving mechanism 462. The power supply apparatus may also supply power to the end effector 430 through an electric wire (not shown) inside the link apparatus 410 or to the thrust generating devices 440 through 440″ combined to the link apparatus 410. The control unit 464 has a wireless communication function to receive a control signal from the control device 160, and may control the moving mechanism 462, the end effector 430, or the plurality of thrust generating devices 440 through 440″ according to the received control signal. The end effector 430 or the plurality of thrust generating devices 440 through 440″ may each operate upon wirelessly receiving a control signal from the control device 160.

Each of the plurality of thrust generating devices 440 through 440″ includes a pair of rotors 443. The plurality of thrust generating devices 440 through 440″ are provided per link 441 of the link apparatus 410 to move the link 441. In FIG. 6, different types of the thrust generating devices 440 through 440″ are provided for the link 441, but the structures or number of thrust generating devices combined to the link 411 may vary.

In the multi-link type working apparatus 400 according to the current embodiment, since the link apparatus 410 is combined to the moving apparatus 460, it is easy to move the link apparatus 410 to a work site, and thus the work site may be easily changed. The moving apparatus 460 may have an unmanned ground vehicle (UGV) structure, or may alternatively have any structure having a moving function.

As described above, the multi-link type working apparatuses 100, 200, and 400 according to one or more exemplary embodiments use the thrust generating devices 140, 240, 440, 440′, and 440″ as actuators for moving the links 111, 211, and 411. Accordingly, thrust compensate for self-weights of the links 111, 211, and 411, and thus the lengths or numbers of the links 111, 211, and 411 may vary and the degree of freedom of the link apparatuses 110, 210, and 410 may easily expand.

One or more exemplary embodiments are described above, but the range of embodiments is not limited thereto.

For example, a thrust generating device may have any structure, for example, may include a single rotor, as well as a multi-rotor type UAV described above.

Also, an end effector may be a replacement type or a fixed type and may be a gripper, a driver, a spanner, a nail gun, or a camera. As occasion demands, an end effector may not be used, and at this time, various works may be performed by moving a link apparatus by using a plurality of thrust generating devices.

A multi-link type working apparatus moved by a thrust generating device, according to an exemplary embodiment, may variously expand lengths of links, the number of links, and the freedom of movement by using the thrust generating device as an actuator for moving the links, compared to a general multi-link type working apparatus that uses a motor or a hydraulic cylinder as an actuator.

Also, the multi-link type working apparatus may perform various mid-air works by lifting a link apparatus mid-air by using the plurality of thrust generating devices. Accordingly, the multi-link type working apparatus may be used in various fields, such as fields of structure evaluation and maintenance operations of suspension bridges or power line towers, fields of reconnaissance activities, firefighting fields, and entertainment fields of performances or parades using giant dolls.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A multi-link type working apparatus moved by a thrust generating device, the multi-link type working apparatus comprising:
a link apparatus that comprises a plurality of links and at least one joint connecting two neighboring links between each of the plurality of links;
a plurality of thrust generating devices that comprise a control module enabling communication between an external device and a rotor generating thrust to control operations of the rotor, and are respectively combined to the plurality of links of the link apparatus to move the plurality of links; and
a control device that comprises a controller in which a control process for controlling the plurality of thrust generating devices is stored, and a communicator transmitting a control signal to the plurality of thrust generating device according to the control process.

2. The multi-link type working apparatus of claim 1, further comprising at least one end effector that has a working function and is combined to the link apparatus.

3. The multi-link type working apparatus of claim 1, further comprising a plurality of link connecting apparatuses that detachably connect the plurality of links of the link apparatus and the plurality of thrust generating devices between the plurality of links and the plurality of thrust generating devices.

4. The multi-link type working apparatus of claim 3, wherein the plurality of link connecting apparatuses comprise a joint structure that adjusts an angle of the plurality of thrust generating devices with respect to the plurality of links of the link apparatus.

5. The multi-link type working apparatus of claim 1, wherein the plurality of thrust generating devices are respectively electrically connected to the plurality of links of the link apparatus.

6. The multi-link type working apparatus of claim 1, wherein each of the plurality of thrust generating devices comprises a multi-rotor type unmanned aerial vehicle (UAV) comprising a plurality of the rotors.

7. The multi-link type working apparatus of claim 1, further comprising a base that supports the link apparatus as any one of the plurality of links of the link apparatus is connected to the base.

8. The multi-link type working apparatus of claim 7, further comprising a power supply apparatus that supplies power to the plurality of thrust generating device through the plurality of links of the link apparatus.

9. The multi-link type working apparatus of claim 1, further comprising a moving apparatus that supports the link apparatus as any one of the plurality of links of the link apparatus is connected to the moving apparatus, and is movable by comprising a moving mechanism.
